(19) United States
(12) Patent Application Publication
(10) Pub. No.: US 2013/0222655 A1
(43) Pub. Date: Aug. 29, 2013

(54) IMAGE CAPTURE SYSTEM AND IMAGE PROCESSING METHOD APPLIED TO AN IMAGE CAPTURE SYSTEM

(71) Applicant: HTC Corporation, (US)

(72) Inventors: Yu-Chun Peng, Taoyuan County (TW); Wan-Ju Tseng, Taoyuan County (TW); Wei-Ting Liu, Taoyuan County (TW)

(73) Assignee: HTC CORPORATION, Taoyuan County (TW)

(21) Appl. No.: 13/773,613

(22) Filed: Feb. 21, 2013

Related U.S. Application Data
(60) Provisional application No. 61/602,627, filed on Feb. 24, 2012.

(51) Int. Cl. H04N 5/217

(52) U.S. Cl. CPC H04N 5/217
USPC 348/242

(57) ABSTRACT

An image capture system comprises an image sensor module, a pre-processing unit, and an image processing unit, where the pre-processing unit comprises a de-noise module. The image sensor module is configured for capturing images corresponding to at least one scene and outputting raw image data accordingly. The pre-processing unit is coupled to the image sensor module, where the de-noise module is configured for executing de-noise operation on the raw image data in raw image domain to generate de-noised raw image data. The image processing unit is coupled to the pre-processing unit and configured for converting the de-noised raw image data into RGB image data in RGB domain.

### CROSS REFERENCE TO RELATED APPLICATIONS

This application claims the benefit of U.S. Provisional Application No. 61/602,627, filed on Feb. 24, 2012 and entitled “Image De-noise Method,” the contents of which are incorporated herein by reference.

### BACKGROUND OF THE INVENTION

1. Field of the Invention

The present invention relates to an image capture system and an image processing method applied to the image capture system, and particularly to an image capture system and an image processing method applied to the image capture system that can utilize a pre-processing unit of the image capture system to reduce burden of an image processing unit of the image capture system.

2. Description of the Prior Art

In the prior art, after raw image data are generated by an image sensor module of an image capture device, the raw image data have to be converted into RGB image data for following processes. Therefore, an image signal processor of the image capture device has to convert the raw image data into the RGB image data through a predetermined process (e.g. a de-mosaic process) before following processes are executed. After the raw image data are converted into the RGB image data, the image signal processor can executed following processes on the RGB image data. Then, the RGB image data can be converted into YUV image data for de-noise process.

However, after raw image data are generated by the image sensor module, the image signal processor first has to convert the raw image data into RGB image data, and then performs following processes on the RGB image data and the de-noise process on YUV image data derived from the RGB image data. Therefore, the image signal processor may have a very heavy burden, resulting in the image signal processor being a bottleneck when the image capture device processes images.

### SUMMARY OF THE INVENTION

An embodiment provides an image capture system. The image capture system comprises an image sensor module, a pre-processing unit, and an image processing unit, where the pre-processing unit comprises a de-noise module. The image sensor module is configured for capturing images corresponding to at least one scene and outputting raw image data accordingly. The pre-processing unit is coupled to the image sensor module, where the de-noise module is configured for executing de-noise operation on the raw image data in raw image domain to generate de-noised raw image data. The image processing unit is coupled to the pre-processing unit and configured for converting the de-noised raw image data into RGB image data in RGB domain.

Another embodiment provides an image processing method applied to an image capture system. The image processing method comprises capturing images corresponding to at least one scene and outputting raw image data accordingly; executing de-noise operation on the raw image data in raw image domain to generate de-noised raw image data; and converting the de-noised raw image data into RGB image data in RGB domain.

The present invention provides an image capture system and an image processing method applied to the image capture system. The image capture system and the image processing method utilize a pre-processing unit to execute de-noise operation on raw image data in raw image domain to generate de-noised raw image data, instead of executing the de-noise operation on YUV image data derived from RGB image data in RGB domain.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an image capture system according to an embodiment.

FIG. 2 is a flowchart illustrating an image processing method applied to an image capture system according to another embodiment.

FIG. 3 is a flowchart illustrating an image processing method applied to an image capture system according to another embodiment.

### DETAILED DESCRIPTION

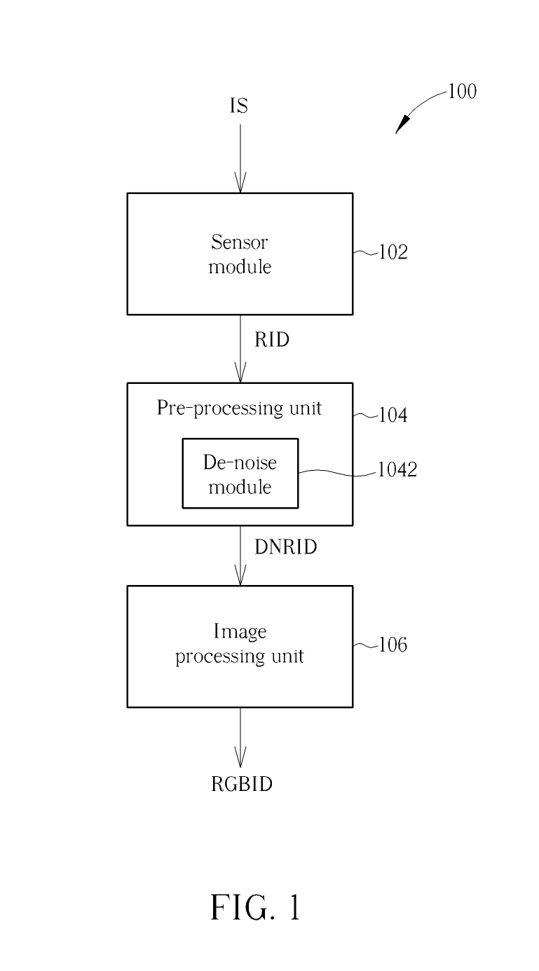

Please refer to FIG. 1. FIG. 1 is a diagram illustrating an image capture 100 according to an embodiment. As shown in FIG. 1, the image capture system 100 comprises an image sensor module 102, a pre-processing unit 104, and an image processing unit 106, where the pre-processing unit 104 comprises a de-noise module 1042, and the de-noise module 1042 can be a Bayer filter or a Wiener filter. But, the present invention is not limited to the de-noise module 1042 being a Bayer filter or a Wiener filter. That is to say, the de-noise module 1042 can be another suitable filter capable to perform image de-noise. The image sensor module 102 is configured for capturing images IS corresponding to at least one scene and outputting raw image data RID accordingly. The raw image data RID is in a raw image domain, which is not visible to human eye. Therefore, in order to present the images to the user, the raw image data RID has to be converted from raw image domain to another visible image domain, such as RGB domain. The pre-processing unit 104 is coupled to the image sensor module 102, where the de-noise module 1042 is configured for executing de-noise operation on the raw image data RID in raw image domain to generate de-noised raw image data DNRID, and the de-noise module 1042 can be implemented by hardware or software. The image processing unit 106 is coupled to the pre-processing unit 104 for converting the de-noised raw image data DNRID into RGB image data RGBID in RGB domain, where the image processing unit 106 can utilize a de-mosaic algorithm to convert the de-noise raw image data DNRID into the RGB image data RGBID. But, the present invention is not limited to the image processing unit 106 utilizing the de-mosaic algorithm to convert the de-noised raw image data DNRID into the RGB image data RGBID in RGB domain. That is, the image processing unit 106 can utilize other algorithms to convert the de-noised raw image data DNRID into the RGB image data RGBID. In addition, the pre-processing unit 104 can be further configured for adjusting a combination composed of color, luminance, resolution, and contrast of the raw image data RID. Of course, in another embodiment of the present invention, the pre-processing unit 104 can still execute other processes required by a user on the raw image data RID.

However, in another embodiment of the present invention, the image processing unit 106 can be further configured for adjusting a combination composed of color, luminance, resolution, and contrast of the de-noised raw image data DNRID. Of course, in another embodiment of the present invention, the image processing unit 106 can still execute other processes required by the user on the de-noise raw image data DNRID.

In another embodiment of the present invention, the pre-processing unit 104 is integrated into the image processing unit 106.

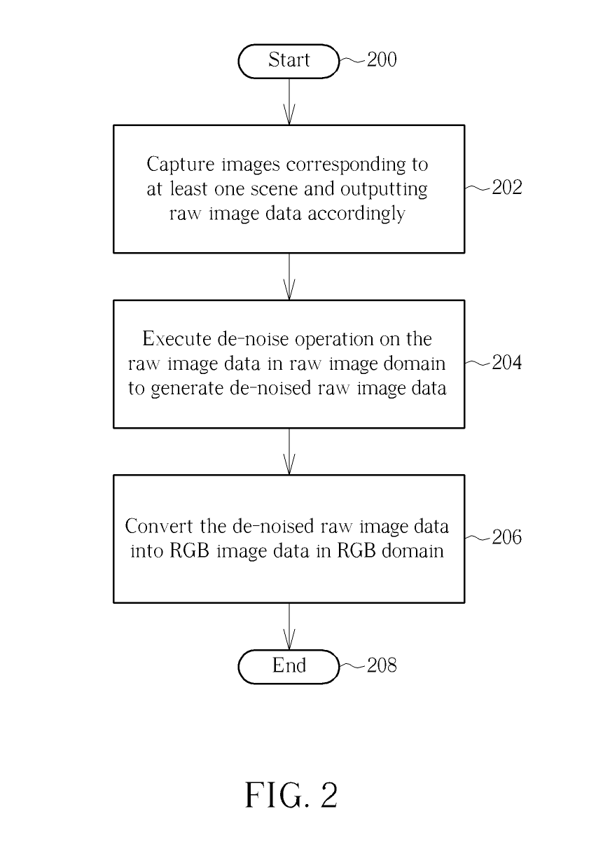

Please refer to FIG. 1 and FIG. 2. FIG. 2 is a flowchart illustrating an image processing method applied to an image capture system according to another embodiment. The image processing method in FIG. 2 is illustrated using the image capture system 100 in FIG. 1. Detailed steps are as follows:

Step 200: Start.

Step 202: Capture images IS corresponding to at least one scene and outputting raw image data RID accordingly.

Step 204: Execute de-noise operation on the raw image data RID in raw image domain to generate de-noised raw image data DNRID.

Step 206: Convert the de-noised raw image data DNRID into RGB image data RGBID in RGB domain.

Step 208: End.

In Step 204, as shown in FIG. 1, the de-noise module 1042 executes the de-noise operation on the raw image data RID in the raw image domain to generate the de-noised raw image data DNRID, where the de-noise module 1042 can be implemented by hardware or software, and the de-noise module 1042 can be a Bayer filter or a Wiener filter. But, the present invention is not limited to the de-noise module 1042 being a Bayer filter or a Wiener filter. That is to say, the de-noise module 1042 can be another suitable filter.

In Step 206, as shown in FIG. 1, the image processing unit 106 converts the de-noised raw image data DNRID into the RGB image data RGBID in RGB domain. Of course, in another embodiment of the present invention, the image processing unit 106 can still execute other processes required by the user on the de-noise raw image data DNRID.

In another embodiment of the present invention, because the pre-processing unit 104 is integrated into the image processing unit 106, Steps 204-206 are executed in the image processing unit 106.

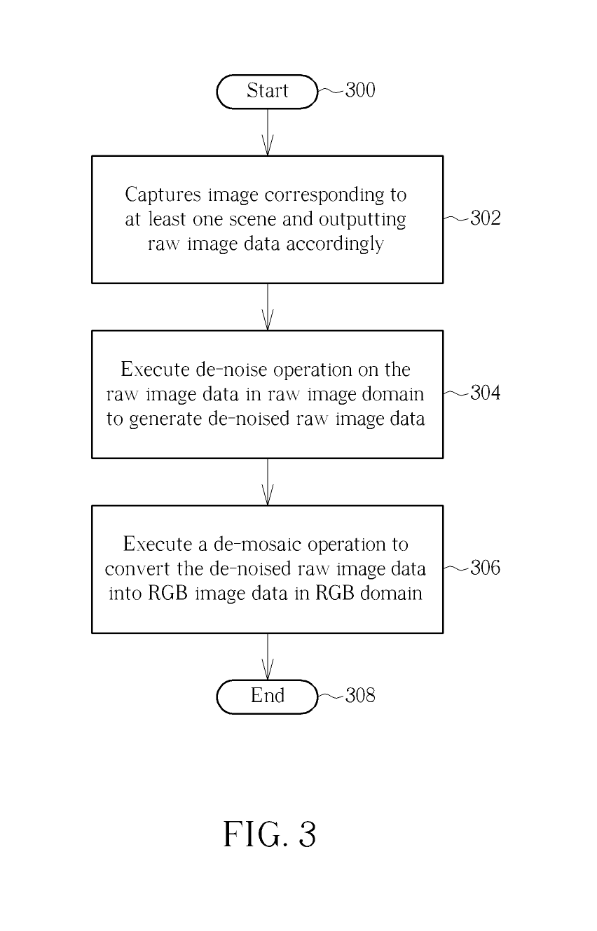

Please refer to FIG. 1 and FIG. 3. FIG. 3 is a flowchart illustrating an image processing method applied to an image capture system according to another embodiment. The image processing method in FIG. 3 is illustrated using the image capture system 100 in FIG. 1. Detailed steps are as follows:

Step 300: Start.

Step 302: Captures image IS corresponding to at least one scene and outputting raw image data RID accordingly.

Step 304: Execute de-noise operation on the raw image data RID in raw image domain to generate de-noised raw image data DNRID.

Step 306: Execute a de-mosaic operation to convert the de-noised raw image data DNRID into RGB image data RGBID in RGB domain.

Step 308: End.

As shown in FIG. 3, in Step 306, the image processing unit 106 executes the de-mosaic operation to convert the de-noised raw image data DNRID into the RGB image data RGBID in RGB domain. But, the present invention is not limited to the image processing unit 106 utilizing the de-mosaic algorithm to convert the de-noised raw image data DNRID into the RGB image data RGBID. That is, the image processing unit 106 can utilize other algorithms to convert the de-noised raw image data DNRID into the RGB image data RGBID. Of course, in another embodiment of the present invention, the image processing unit 106 can still execute other processes required by the user on the de-noised raw image data DNRID. Further, subsequent operational principles of the embodiment in FIG. 3 are the same as those of the embodiment in FIG. 2, so further description thereof is omitted for simplicity.

To sum up, the image capture system and the image processing method applied to an image capture system utilize the pre-processing unit to execute the de-noise operation on raw image data in the raw image domain to generate de-noised raw image data, instead of executing the de-noise operation on YUV image data derived from RGB image data in RGB domain. Therefore, compared to the prior art, the present invention can reduce burden of the image processing unit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image capture system, comprising:
an image sensor module configured for capturing images corresponding to at least one scene and outputting raw image data accordingly;
a pre-processing unit coupled to the image sensor module, wherein the pre-processing unit comprises a de-noise module, and the de-noise module is configured for executing de-noise operation on the raw image data in raw image domain to generate de-noised raw image data; and
an image processing unit coupled to the pre-processing unit configured for converting the de-noised raw image data into RGB image data in RGB domain.

2. The image capture system of claim 1, wherein the pre-processing unit is implemented as a dedicated hardware unit processing in the raw image domain.

3. The image capture system of claim 1, wherein the pre-processing unit is integrated with the image processing unit.

4. The image capture system of claim 1, wherein the de-noise module is a Bayer filter or a Wiener filter.

5. The image capture system of claim 1, wherein the image processing unit utilizes de-mosaic algorithm to convert the de-noised raw image data into the RGB image data.

6. An image processing method applied to an image capture system, the image processing method comprising:
capturing images corresponding to at least one scene and outputting raw image data accordingly to a pre-processing unit;
executing de-noise operation on the raw image data in raw image domain to generate de-noised raw image data; and
converting the de-noised raw image data into RGB image data in RGB domain.

7. The image processing method of claim 6, wherein the de-noise operation is executed by a Bayer filter or a Wiener filter.

8. The image processing method of claim 6, wherein converting of the de-noised raw image data into the RGB image data is performed by a de-mosaic algorithm.

9. The image processing method of claim 6, wherein executing of the de-noise operation is performed in a pre-processing unit and the converting of the de-noised raw image data is performed in an image processing unit.

10. The image processing method of claim 9, wherein the pre-processing unit is a dedicated unit processing in raw image domain.
